(19) United States
(12) Patent Application Publication
(10) Pub. No.: US 2002/0169707 A1
(43) Pub. Date: Nov. 14, 2002

(54) Financial language internet real-time trading

(76) Inventors: Wei Song Koek, Brooklyn, NY (US); Witold Sames, Closter, NJ (US); Mintak Ng, Brooklyn, NY (US)

Correspondence Address: Peter S. Canelias, Attorney at Law, 14th Floor, 445 Park Avenue, New York, NY, 10022, US

(21) Appl. No.: 10/116,525

(22) Filed: Apr. 4, 2002

Related U.S. Application Data
(60) Provisional application No. 60/281,686, filed on Apr. 5, 2001.

(51) Int. Cl. G06F 17/60

(52) U.S. Cl. 705/37

(57) ABSTRACT

The invention relates to a protocol and textually based interface that allows for easy extension, providing enhanced financial language real-time trading of securities via a global computer network. Extensibility is possible by qualifying each specific request as a method, and elements within that method as parameters. The interface raises the level of abstraction from the communication protocol level to a software interface level. This feature provides flexibility in extending the specification.

### BACKGROUND OF THE INVENTION

A protocol is a standard that specifies the format of data as well as a set of rules to be followed for exchanging files or information via a computer network. Protocols are critical to the efficient operation of computer networks. A protocol specifies how a program should prepare data so that it can be sent on to the next stage in the communications process. Traditional protocols use a binary message application program interface (API). An API is the specific method prescribed by a computer operating system or by another application by which a developer writing an application can make requests of the operating system or another application.

The Financial Information Exchange (FIX) format is a messaging standard developed specifically for the real-time electronic exchange of securities transactions. The FIX protocol architecture is layered (or tiered) so that at least two distinct levels of functionality exist: Session and Application. The Session layer deals with the delivery and recovery of the actual Application data. Validation and persistence of the data, along with formatting and other functions, are performed by an application implementing the FIX protocol, commonly referred to as a FIX engine or server. FIX messages are processed, sent and received in strict order of sequence numbers, effectively enabling a built-in recovery mechanism through the detection of gaps in the series of sequence numbers.

FIX is a traditional point-to-point protocol, meaning that multiple connections transmitting like data for the same two counter parties are not implemented. This limits the ability to scale significantly. In addition, a connection between those two counter parties stays open for the duration of the FIX session, requiring special security measures (network, encryption) and operational management.

### SUMMARY OF THE INVENTION

The present invention may be referred to as Financial Language Internet Real-Time Trading (FLIRT). The invention is a transactional lightweight protocol (session implementation) based on the request/response paradigm that allows the transmission of data (here: financial data) in XML-compliant format. FLIRT allows the creation of a secure, scalable and highly available environment that communicates over a global computer network such as the Internet. The purpose of the invention is to connect parties interested in enabling and automating real time electronic trading and other related communications. The invention focuses on the management of the session and uses existing application data defined in an XML format for business-specific purposes. While initially designed to focus on FIXML (an XML representation of the aforementioned FIX standard), the protocol is flexible enough to support other data formats, such as Financial Products Markup Language (FpML™). FpML™ is a business information exchange standard for electronic dealing and processing of financial derivatives instruments, jointly created and maintained by J. P. Morgan and PricewaterhouseCoopers. FLIRT provides a simple, cost-effective way to connect all interested parties for the automated exchange of financial data, therefore achieving greater market efficiency and liquidity.

FLIRT is more than just a protocol; it is also an interface. In contrast to the binary message API used in traditional protocols, the interface of the present invention is textual and “RPC-like,” allowing for easy extension. RPC is an acronym that stands for Remote Procedure Call, which is a protocol, that one software program may use to request a service from another program located in another computer in a network without having to understand network details. Extensibility, the capability of accepting new, user-defined commands, is possible by qualifying each specific request as a method, and elements within that method as parameters. The FLIRT interface raises the level of abstraction from the communication protocol level to a software interface level. This provides flexibility in extending the specification.

FLIRT leverages existing, open standard technologies such as the hypertext transfer protocol (HTTP) and Extensible Markup Language (XML), which allow for greater interoperability, regardless of platform and implementation. HTTP(S) is a variation on the HTTP protocol that provides Secure Socket Layer (SSL) security for online transactions using the World Wide Web (WWW). FLIRT uses the connection-less HTTP(S) as its transport layer, and adds transactional integrity to create a lightweight state/session management capability through use of unique identifiers. This eliminates the need for a traditional point-to-point connection (as is the case in the FIX protocol design today), and provides ordered message processing without the actual session layer associated with heavier-weight protocols. In order to improve performance and scalability, as well as to eliminate single points of failure, multiple sessions between parties are allowed and encouraged to transact simultaneously. The need for a lightweight transactional model had so far not been addressed in the financial trading space.

FLIRT uses XML textual data, and the connection-less HTTP(S) protocol. Some may see this as performance degradation, but while XML textual data does indeed require more “space” (bandwidth, or disk space), the combination of session-less connections with the ability to have many of these connections at the same time, and with XML compression technology, it offsets these performance bottlenecks. This allows the user to scale the implementation to requirements, with no actual decrease in performance.

Connection-less in this context means that every time a request/response cycle is completed, the connection used for that cycle becomes available for the next cycle. This also means that scalability is not only a function of the amount of HTTP servers one employs, since a good HTTP server implementation can have thousands of simultaneous connections.

Both HTTP(S) and XML technologies are widely implemented and available. There is hardly any business or organization that is incapable of handling HTTP(S) data. That said, using HTTP(S) dramatically shortens the development cycle for FLIRT-based implementations.

FLIRT is also based (purely from a design point of view) on the Simple Object Access Protocol (SOAP), which can be thought of as “XML-RPC.” SOAP is a way for a program running in one kind of operating system to communicate with a program in the same or a different kind of operating system by using the Internet's HTTP and XML as the mechanisms for information exchange. One can think of FLIRT as a custom implementation of SOAP. The initial release of the FLIRT protocol is based on the XML DTD. Future releases will incorporate XML schema and remain backward compatible with the DTD version. SOAP is not contained in FLIRT.

FLIRT combines the “good parts” from existing specifications and protocols, such as FIX, HTTP, XML and SOAP, to create an optimal solution for transmitting data in a transactional manner, lightweight, secure, and over the Internet.

From a security point of view, an SSL encrypts any and all connections. SSL is a commonly used protocol for managing the security of a message transmission over the Internet. This standard was chosen because of its wide availability and implementation.

The present invention is a pure session protocol. The actual data transported is of no concern to the present invention, as long as it conforms to the DTD or schema loaded by the application implementing the invention. The data does not have to be in FIXML format. FIXML is the FIX Markup Language for application messages (see also the definition provided earlier). It is an XML-derived language, encompassing a series of DTDs, which define the formal representation of FIXML messages.

FLIRT messages do not contain session-level sequence numbers. The order in which messages are received or sent is inconsequential from a session point of view, and parallel processing of multiple transactions is encouraged. Ordered message processing within a transaction is provided by means of transaction-level sequencing; this number can be re-used once the transaction in question is completed.

FLIRT is based on connection and state-less HTTP. This means that a connection for the transmission of transactional messages is made on demand, and given up when the transaction completes. Transaction as used herein is defined as a substantially complete interchange between two or more things. Additionally, multiple connections can be made simultaneously. The implementation of FLIRT using standard Internet technology (HTTP, Secure Sockets Layer (SSL)) which is a commonly-used protocol for managing the security of a message transmission on the Internet), minimizes implementation time, allows for faster and more economical connectivity, and provides a path to scalability.

Thus, among the objects of the present invention are:

To provide a financial language real-time electronic trading protocol and interface employing open standards;

Another object of the invention is to provide a financial language real-time electronic trading protocol and interface having maximum extensibility;

Another object of the invention is to provide a financial language real-time electronic trading protocol and interface that allows multiple, simultaneous sessions for optimal performance (parallel processing);

Another object of the invention is to provide a financial language real-time electronic trading protocol and interface allowing for pooling and aggregation of connections;

Another object of the invention is to provide a financial language real-time electronic trading protocol and interface that provides security for all transactions;

Another object of the invention is to provide a financial language real-time electronic trading protocol and interface that allows the maximum degree of scalability;

Another object of the invention is to provide a financial language real-time electronic trading protocol and interface that is highly available; and

Another object of the invention is to provide a financial language real-time electronic trading protocol and interface that allows for a high degree of transactional integrity.

### BRIEF DESCRIPTION OF THE DRAWINGS

FIG. 1 is a flow diagram showing the layered architecture of FIX, and the actual implementation using a FIX engine;

FIG. 2 is a flow diagram showing a sample implementation of the present invention;

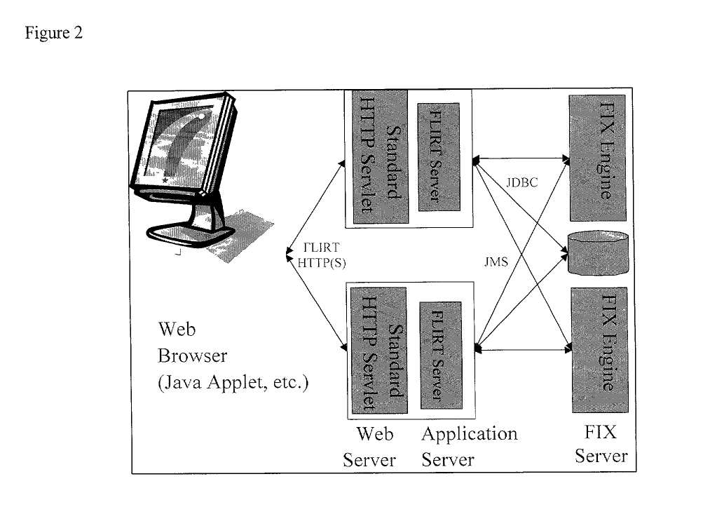

FIG. 3 is a flow diagram showing a transaction accomplished by the present invention.

### DETAILED DESCRIPTION

This section describes the invention in the context of enterprise architecture, i.e., the overall conceptual design of a computer network showing how the various components interact. One especially important point is the distinction between the scope of FIX and the scope of the present invention. Although it is assumed that a person of ordinary skill in the art has a basic understanding of the traditional FIX-based architecture, it is explained here briefly.

FIX is a standard for connecting a buy side institution to a sell side broker, an exchange, Electronic Communication Network (ECN), or other similar entity. An ECN refers to any electronic system that widely disseminates to third parties orders entered by an exchange market maker or over the counter (OTC) market maker, and permits such orders to be executed against in whole or in part.

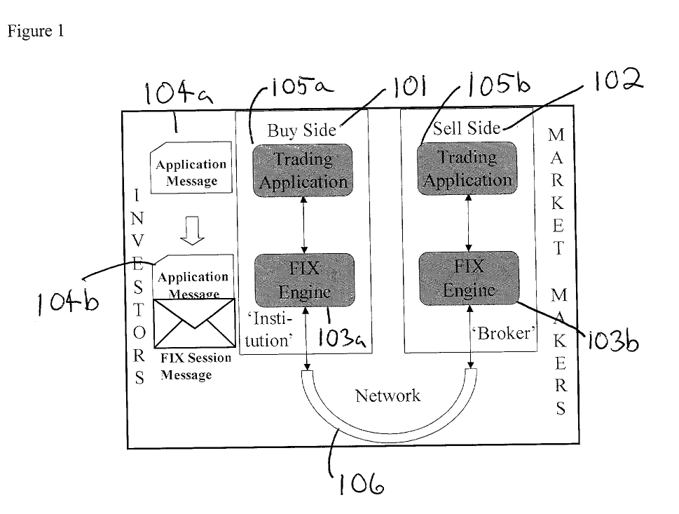

FIG. 1 illustrates the layered architecture of FIX. The diagram shows three architectural layers (this is the normal pattern for middleware). The current FIX standard (4.2) does not carefully distinguish these three layers. One of the roles of the FIXML (using XML as the FIX syntax) initiative is to make this clearer. The following is taken from a FIXML white paper:

“The separation of application and session layers creates opportunities to break away from the traditional methods of implementing FIX. Session and security levels can develop unconstrained without affecting application level messages. A new security model could be embraced or the session layer could be implemented using off-the-shelf technology.”

The first layer is the FIX-enabled application-trading in this case. The buy side application 101 exchanges trading messages 104a, b with the sell side application 102. In order for the messages to be exchanged, the applications 105a, b call on the services of a FIX engine 103a, b.

The second layer is a FIX engine on both the buy side 103a and the sell side 103b. The FIX engines 103a, b ensure that the application messages 104a and b are correctly sent from the buy side 101 to the sell side 102. FIX defines both the application messages for trading and also the way that the FIX engines maintain the FIX session between them, ensuring that messages are properly delivered. The FIX engine is, therefore, a form of enterprise middleware. The FIX session messages “wrap” the application message, like putting a letter into an envelope 104b.

The third layer is a network connection 106. It transmits the FIX message from one FIX engine to the other. Typically, this is a Transmission Control Protocol/Internet Protocol (TCP/IP) sockets connection. FIX does not limit what kinds of transports it can run over.

Although FIG. 1 shows a single FIX session, it is possible for a FIX engine to maintain several FIX sessions and so to provide access to, in effect, a network of FIX servers.

In order for an organization to make use of one of the trading capabilities standardized by the FIX protocol, an application has to be written that will be used by traders or market makers. The business objects or messages standardized by FIX include: Indications of Interest, Quotes, Market Data, Orders, Executions, Allocations, and Settlement Instructions (among others).

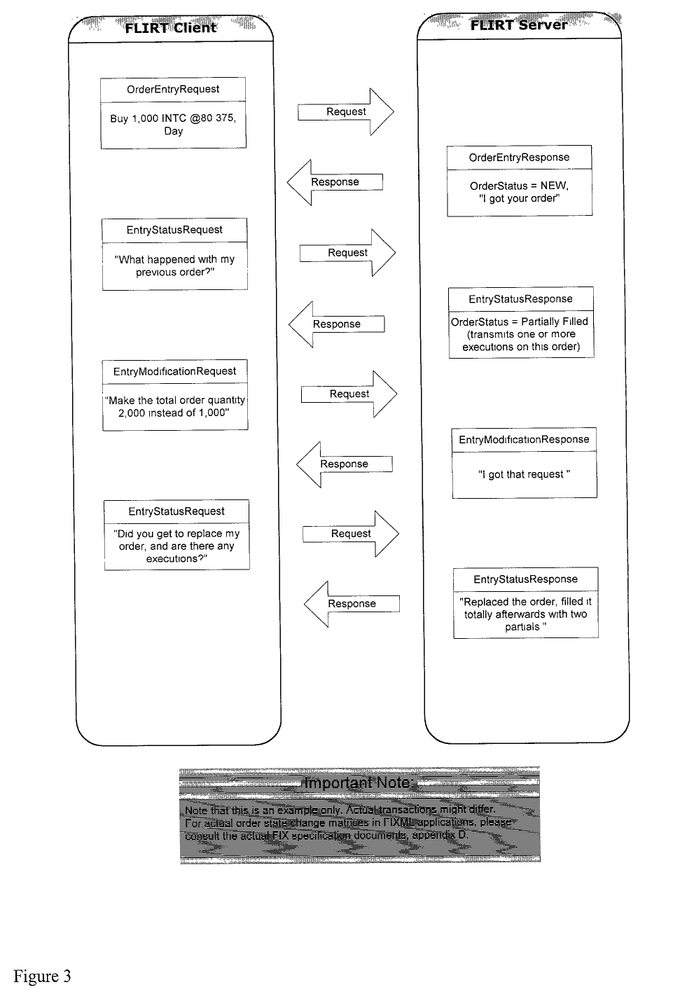

FIG. 3 illustrates an example of the sample flow of a financial transaction using the present invention. The client 109 initiates the process with an order entry request 110, here shown by example as an order to buy 1000 shares. The request is transmitted to the server 111, which issues an order entry response 112, confirming receipt of the order. The client 109 transmits an entry status request 113, which queries the status of the previous order. The server 111 transmits an entry status response 114 here showing partial fulfillment, transmitting one or more executions on this order. Client 109 transmits an entry modification request, which increases the number of shares ordered to 2000. The server 111 transmits an entry modification response 116 confirming receipt of the request. Client 100 transmits an entry status request 117, which queries the status of the replacement order and inquires as to executions. The server 111 transmits an entry status response 118, confirming replacement of the order and total fulfillment with two partial executions.

Since other modifications or changes will be apparent to those skilled in the art, there have been described above the principles of this invention in connection with specific apparatus and method steps, it is to be clearly understood that this description is made only by way of example and not as a limitation to the scope of the invention.

What is claimed is:

1. A process of implementing real-time financial trading comprising the steps of:
initiation of a transaction with an order entry request having an order from a client;
transmission of said order entry request and order to a server;
said server issuing an order entry response confirming receipt of said order entry request and order;
said client transmitting an entry status request, querying status of said order; and
said server transmitting an entry status response and transmitting an execution of said order.

2. The process of claim 1, further comprising the steps of:
said client transmitting an entry modification request having a replacement order and querying status of said replacement order and inquiring as to executions; and
said server transmitting an entry status response confirming order replacement and transmitting a fulfillment of said replacement order.

3. The process of claim 1, wherein said hypertext transfer protocol establishes a connection on demand and terminates said connection upon completion of a transaction.

4. A financial transaction system with a protocol and interface comprising:
a server having a financial protocol engine;
said financial protocol engine having a financial protocol;
a hypertext transfer server having a hypertext transfer protocol, in communication with said financial protocol engine and said financial protocol;
a financial language trading protocol server intermediate and operably communicating with said financial protocol engine and said hypertext transfer server;
said financial language trading server having a protocol and an interface for enabling real-time transmission of a plurality of messages to and from a client though a plurality of connections.

5. The invention of claim 4, wherein said hypertext transfer protocol has a secure socket layer.

6. The invention of claim 4, wherein said hypertext transfer protocol is a connection-less hypertext transfer protocol.

7. The invention of claim 4, wherein said financial protocol engine is an open financial information exchange protocol.
